(19) United States
(12) Patent Application Publication
(10) Pub. No.: US 2011/0005487 A1
(43) Pub. Date: Jan. 13, 2011

(54) Variable Intake System

(75) Inventors: Ha Dong BONG, Ansan-city (KR); Seong Hyuk KANG, Hwaseong-city (KR); Wootae KIM, Suwon-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/568,353

(22) Filed: Sep. 28, 2009

(30) Foreign Application Priority Data
Jul. 7, 2009 (KR) 10-2009-0061701

(51) Int. Cl. F02M 35/10

(52) U.S. Cl. 123/184.42; 123/184.57; 123/184.56

(57) ABSTRACT

A variable intake system may include intake runners that are respectively connected to a plurality of cylinders to supply air that flows therein to the cylinders, a plenum, one side of which is connected to the intake runners and distributes the air to the intake runners, a first resonance pipe, one end of which is connected to the other side of the plenum to supply the air therein, a second resonance pipe, one end of which is connected to the other side of the plenum to supply the air therein, the length thereof being shorter than that of the first resonance pipe and the cross-section thereof being wider than that of the first resonance pipe, and a junction pipe connected to the other ends of the first and second resonance pipes and supplying the air to the first and second resonance pipes respectively from an intake line.

### CROSS-REFERENCE TO RELATED APPLICATION

The present application claims priority to Korean Patent Application No. 10-2009-0061701 filed on Jul. 7, 2009, the entire contents of which are incorporated herein for all purposes by this reference.

### BACKGROUND OF THE INVENTION

1. Field of the Invention

The present invention relates to a variable intake system. More particularly, the present invention relates to a variable intake system for efficiently supplying air that flows therein from the outside.

2. Description of Related Art

Generally, an intake manifold is an induction space for guiding air that flows therein from the throttle body to uniformly divide the air or the air/fuel mixed gas into several combustion chambers.

The intake system includes several intake runners that are connected to the intake ports and a plenum that is connected to the intake runners, and the engine efficiency is varied according to the shape and the specifications of the intake manifold.

Meanwhile, studies for improving the intake efficiency by using pulsation or resonance that is generated by air that is supplied into the cylinder in the intake manifold have been actively undertaken.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a variable intake system having advantages of using resonance or pulsation that is generated therein so as to improve intake efficiency when air from the outside is supplied into the cylinder.

In an aspect of the present invention, a variable intake system, may include intake runners that are respectively connected to a plurality of cylinders to supply air that flows therein to the cylinders, a plenum, one side of which is connected to the intake runners and distributes the air to the intake runners, a first resonance pipe, one end of which is connected to the other side of the plenum to supply the air therein, a second resonance pipe, one end of which is connected to the other side of the plenum to supply the air therein, the length thereof being shorter than that of the first resonance pipe and the cross-section thereof being wider than that of the first resonance pipe, and a junction pipe connected to the other ends of the first and second resonance pipes and supplying the air to the first and second resonance pipes respectively from an intake line.

The plenum may include an upper plenum and a lower plenum that are divided in up and down directions by a plenum barrier, and the first and second resonance pipes respectively include first upper/lower pipes and second upper/lower pipes that are respectively divided by a resonance pipe barrier in up and down directions, and the plenum barrier and the resonance pipe barrier are connected to each other to be integrally formed.

In another aspect of the present invention, the variable intake system may include a pulsation pipe that is diverged from the plenum and an end portion thereof is closed.

In further another aspect of the present invention, the variable intake system may include a pulsation pipe that is diverged from the plenum and an end portion thereof is closed, wherein the plenum includes an upper plenum and a lower plenum that are divided in up and down directions by a plenum barrier, the pulsation pipe includes an upper pulsation pipe and a lower pulsation pipe that are divided in up and down directions by a pulsation pipe barrier, and the plenum barrier and the pulsation pipe barrier are connected to each other to be integrally formed.

In still further another aspect of the present invention, the variable intake system may include a pulsation pipe valve that selectively open or closes a fluid communication between the upper pulsation pipe and the lower pulsation pipe, an upper resonance pipe valve and a lower resonance pipe valve that are respectively disposed within the second upper resonance pipe and the second lower resonance pipe to selectively control the flow of the air therein, driving portions that operate the pulsation pipe valve, the upper resonance pipe valve, and the lower resonance pipe valve respectively, and a control portion that controls the driving portions according to a rotation speed or driving conditions of an engine.

The control portion may close the pulsation pipe valve, the upper resonance pipe valve, and the lower resonance pipe valve while the rotation speed of the engine is in a low range, open the pulsation pipe valve and closes the upper resonance pipe valve and the lower resonance pipe valve while the rotation speed of the engine is in a medium-low range, close the pulsation pipe valve and opens the upper resonance pipe valve and the lower resonance pipe valve while the rotation speed of the engine is in a medium-high range, and open the pulsation pipe valve, the upper resonance pipe valve, and the lower resonance pipe valve while the rotation speed of the engine is in a high range.

In another aspect of the present invention, the variable intake system may include a pulsation pipe that is diverged from the plenum and the end portion is closed, wherein the plenum, the pulsation pipe, and the first and second resonance pipes are respectively divided into an upper plenum and a lower plenum, an upper pulsation pipe and a lower pulsation pipe, a first upper resonance pipe and a first lower resonance pipe, and a second upper resonance pipe and a second lower resonance pipe, by a barrier.

In further another aspect of the present invention, a direct injection engine system may include a variable intake system and a fuel system that directly injects fuel into a cylinder so as to generate the driving power.

As stated above, in the variable intake system according to the present invention, the resonance pipe valve and the pulsation pipe valve that are respectively mounted in the resonance pipe and the pulsation pipe are selectively opened or closed according to the rotation speed of the engine to use the pulsation or the resonance that is generated in the intake system so as to improve intake efficiency.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic top plan view of a variable intake system according to an exemplary embodiment of the present invention.

FIG. 2 is a cross-sectional view of a variable intake system along the II-II line of FIG. 1.

FIG. 3 is a schematic front view of a variable intake system according to an exemplary embodiment of the present invention.

FIG. 4 is a cross-sectional view of a variable intake system along the IV-IV line of FIG. 1.

FIG. 5 is a table showing detailed specifications of a variable intake system according to an exemplary embodiment of the present invention.

FIG. 6 is a table showing the relationship between engine speed and operation state of valves of a variable intake system according to an exemplary embodiment of the present invention.

FIG. 7 is a graph showing the relationship between engine speed and intake efficiency of a variable intake system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

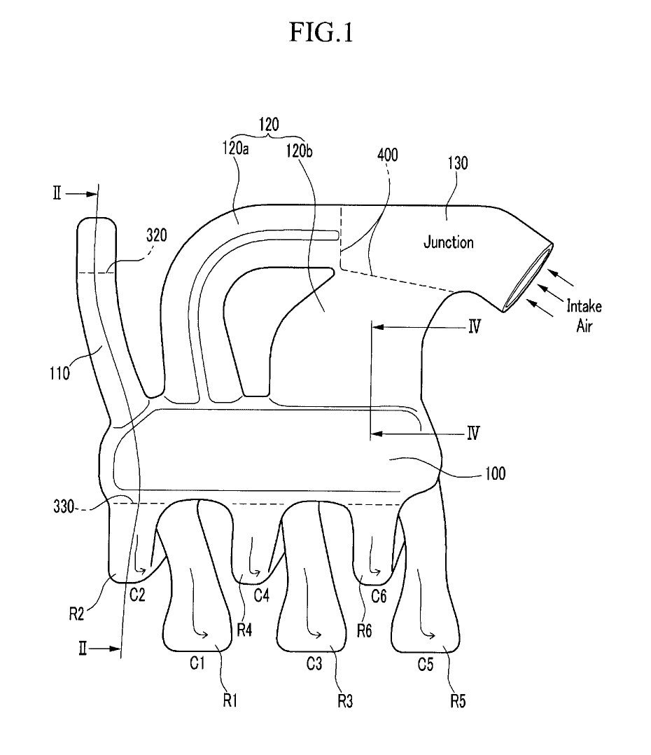

FIG. 1 is a schematic top plan view of a variable intake system according to an exemplary embodiment of the present invention.

Referring to FIG. 1, a variable intake system includes first, second, third, fourth, fifth, and sixth cylinders (C1, C2, C3, C4, C5, and C6), first, second, third, fourth, fifth, and sixth intake runners (R1, R2, R3, R4, R5, and R6), a plenum 100, resonance pipe 120 including first and second resonance pipes 120a and 120b, a junction pipe 130, and a pulsation pipe 110.

The first, second, third, fourth, fifth, and sixth intake runners (R1, R2, R3, R4, R5, and R6) are respectively diverged from one side (the lower side of FIG. 1) of the plenum 100 to be connected to the first, second, third, fourth, fifth, and sixth cylinders (C1, C2, C3, C4, C5, and C6) such that the air is supplied from the plenum 100 to the respective cylinders (C1-C6).

The pulsation pipe 110 is diverged from the other side (the upper side of FIG. 1) of the plenum 100 to be extended by a predetermined length, and the plenum 100 and the junction pipe 130 are connected to each other through the first and second resonance pipes 120a and 120b such that the outside air is supplied from the junction pipe 130 to the plenum 100.

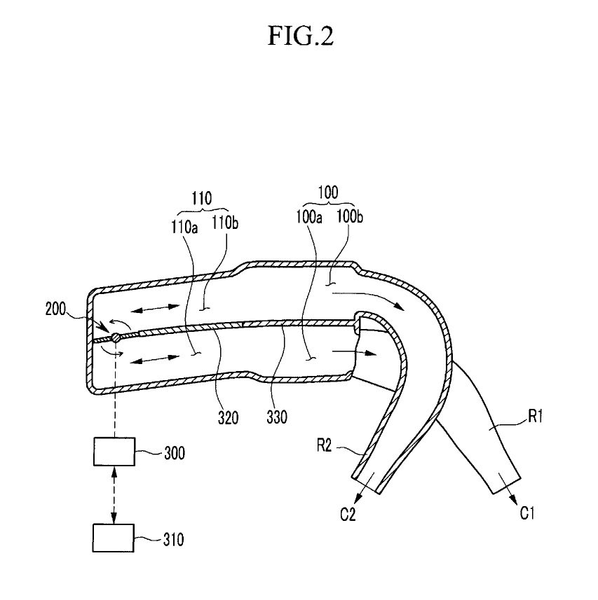

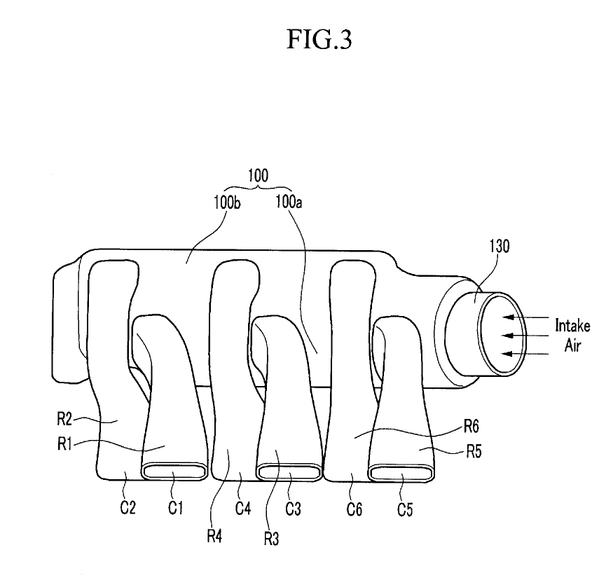

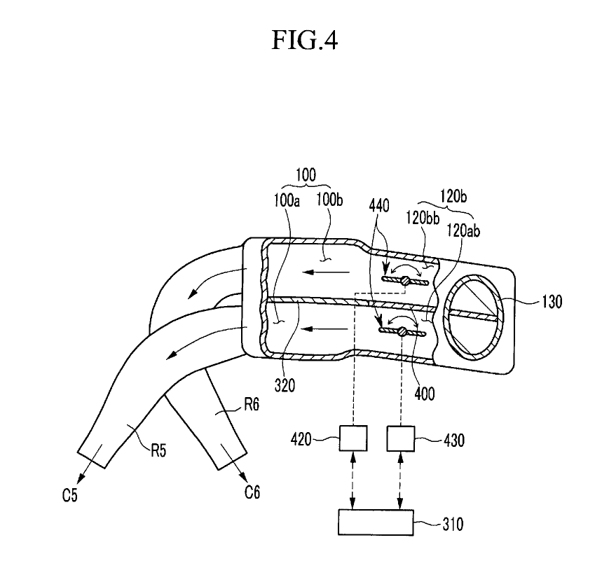

FIG. 2 is a cross-sectional view of a variable intake system along the II-II line of FIG. 1, FIG. 3 is a schematic front view of a variable intake system according to an exemplary embodiment of the present invention, and FIG. 4 is a cross-sectional view of a variable intake system along the IV-IV line of FIG. 1.

Referring to FIG. 2, FIG. 3, and FIG. 4, the pulsation pipe 110 is divided into an upper pulsation pipe 110b and a lower pulsation pipe 110a by a pulsation pipe barrier 320, and a pulsation pipe valve 200 is disposed in the pulsation pipe barrier 320 to connect or close the upper pulsation pipe 110b with or from the lower pulsation pipe 110a.

If the pulsation pipe valve 200 is opened, the upper pulsation pipe 110b and the lower pulsation pipe 110a are connected to each other such that the inflow air can move from the upper pulsation pipe 110b to the lower pulsation pipe 110a and vice versa, and if the pulsation pipe valve 200 is closed, the upper pulsation pipe 110b and the lower pulsation pipe 110a are isolated from each other.

Here, the pulsation pipe valve 200 is operated by a driving portion 300, and the driving portion 300 is controlled according to the control signal of a control portion 310. In the present exemplary embodiment, the control portion 310 controls the driving portion 300 according to the rotation speed of the engine.

A resonance pipe barrier 400 is formed from the boundary between the junction pipe 130 and the first and second resonance pipes 120a and 120b such that the first and second resonance pipes 120a and 120b are respectively divided into a first upper resonance pipe and a first lower resonance pipe, and a second upper resonance pipe 120bb and a second lower resonance pipe 120ab.

Further, the plenum 100 is divided into an upper plenum 100b and a lower plenum 100a by a plenum barrier 330, and the pulsation pipe 110 is divided into an upper pulsation pipe 110b and a lower pulsation pipe 110a by a pulsation pipe barrier 320.

In an exemplary embodiment of the present invention, the resonance pipe barrier 400, the plenum barrier 330, and the pulsation pipe barrier 320 are connected to each other to form one barrier, that is, they are integrally formed.

Accordingly, the air passing the junction pipe 130 is divided by the barriers 320, 330, and 400 to be supplied to the upper and lower plenums 100b and 100a, the first, third, and fifth intake runners R1, R3, and R5 supply the inflow air to the first, third, and fifth cylinders C1, C3, and C5 from the lower plenum 100a, and the second, fourth, and sixth intake runner R2, R4, and R6 supply the inflow air to the second, fourth, and sixth cylinders C2, C4, and C6 from the upper plenum 100b.

Referring to FIG. 1, when the first resonance pipe 120a is compared with the second resonance pipe 120b, the length of the first resonance pipe 120a is longer than that of the second resonance pipe 120b, but the diameter of the first resonance pipe 120a is smaller than that of the second resonance pipe 120b.

Referring to FIG. 4, the first and second resonance pipes 120a and 120b are divided into the lower and upper parts by the resonance pipe barrier 400, a valve is not disposed within the first resonance pipe 120a such that the inflow air can always flow, but a valve is disposed within the second resonance pipe 120b.

The second resonance pipe 120b is divided into the second upper resonance pipe 120bb and the second lower resonance pipe 120ab by the resonance pipe barrier 400, and resonance pipe valves 440 are respectively disposed within the second upper resonance pipe 120bb and the second lower resonance pipe 120ab.

The resonance pipe valves 440 open or close the second upper resonance pipe 120bb or the second lower resonance pipe 120ab such that the flow of air can be controlled. The resonance pipe valves 440 are operated by respective driving portions 420 and 430, and the driving portions 420 and 430 are controlled by the control portion 310. In the present exemplary embodiment, the control portion 310 controls the driving portions 420 and 430 according to the rotation speed of the engine.

In an exemplary embodiment of the present invention, the driving portions 300, 420, and 430 can be operated by a motor, air pressure, hydraulic pressure, or a solenoid.

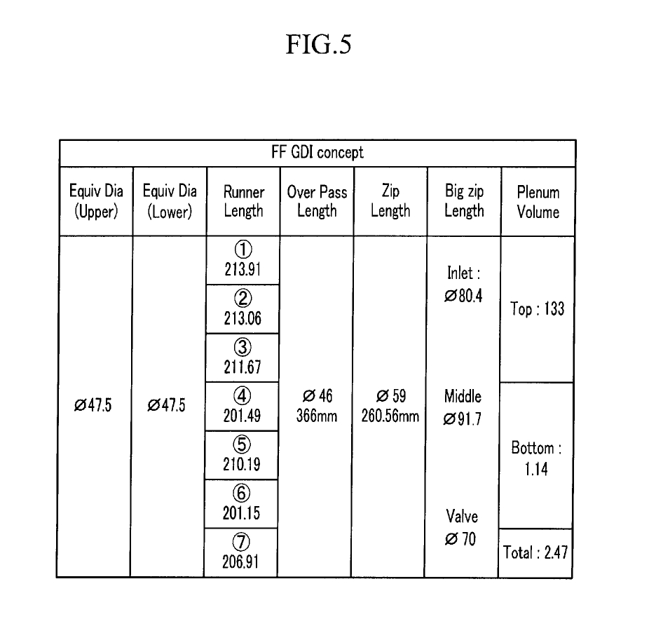

FIG. 5 is a table showing the detailed specifications of a variable intake system according to an exemplary embodiment of the present invention.

Referring to FIG. 5, the diameter of the pulsation pipe (110, over pass) is 46 mm and the length thereof reaches 366 mm, the diameter of the first resonance pipe (120a, small zip) is 59 mm and the length thereof reaches 260.56 mm, the inlet diameter of the second resonance pipe (120b, big zip) is 80.4 mm and the outlet diameter thereof is 91.7 mm, and the diameter of the resonance pipe valve 440 is 70 mm.

Further, the volume of the upper plenum 100b is 1.33 L and the volume of the lower plenum 100a is 1.14 L. Also, the first, second, third, fourth, fifth, and sixth intake runners (R1, R2, R3, R4, R5, and R6) have an average length of 206.91 mm.

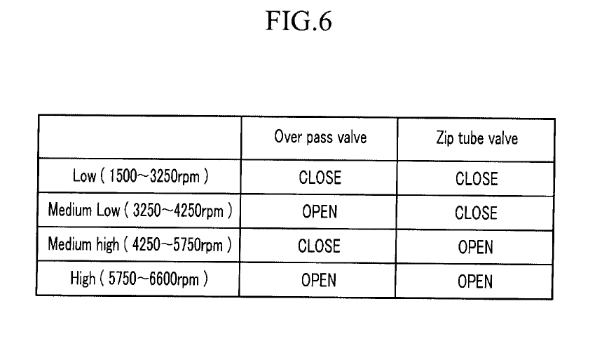

FIG. 6 is a table showing the relation between engine speed and the operation state of valves of a variable intake system according to an exemplary embodiment of the present invention.

Referring to FIG. 6, the pulsation pipe valve (200, overpass valve) and the resonance pipe valve (440, zip tube valve) are closed in the low range of the engine speed (low, 1500 to 3250 rpm).

Further, the pulsation pipe valve (200, overpass valve) is opened and the resonance pipe valve (440, zip tube valve) is closed in the medium low range of the engine speed (medium low, 3250 to 4250 rpm).

Also, the pulsation pipe valve (200, overpass valve) is closed and the resonance pipe valve (440, zip tube valve) is opened in the medium high range of the engine speed (medium high, 4250 to 5750 rpm).

Further, the pulsation pipe valve (200, overpass valve) and the resonance pipe valve (440, zip tube valve) are opened in the high range of the engine speed (high, 5750 to 6600 rpm).

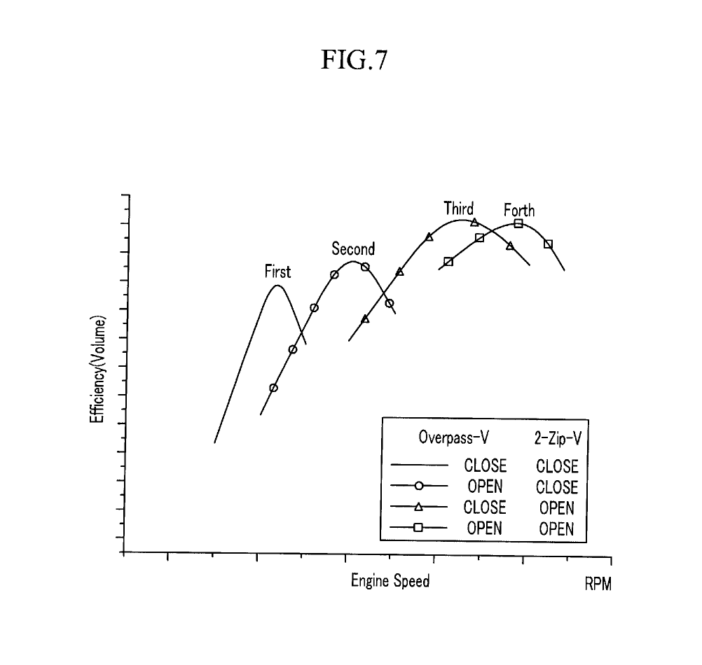

FIG. 7 is a graph showing the relationship between engine speed and intake efficiency of a variable intake system according to an exemplary embodiment of the present invention.

Referring to FIG. 7, the horizontal axis denotes the rotation speed of the engine, and the vertical axis denotes intake efficiency of the variable intake system.

The intake efficiency is varied according to the opening and closing of the pulsation pipe valve 200 and the resonance pipe valve 440, and the pulsation pipe valve 200 and the resonance pipe valve 440 are selectively operated according to the rotation speed of the engine so as to maximize the intake efficiency.

In an exemplary embodiment of the present invention, when the air is supplied to several cylinders, because the cylinders intermittently inhale the air, a pulsation is formed within the plenum 100, and as the rotation speed of the engine increases, the pulsation frequency thereof increases.

The pulsation is alternately formed in an upper and a lower direction according to the ignition order of a V6 engine, and the intake efficiency is improved only at one specific rotation speed by the length or the cross-section between the cylinder that is being ignited and the cylinder that is to be ignited.

Also, when the pulsation frequency becomes equal to the natural vibration value of the resonance pipe and the plenum in another specific rotation speed, the intake efficiency is increased by the resonance.

It is difficult to design an intake system that fully uses the pulsation or the resonance in a specific driving range, but as described above, the pulsation or the resonance that is formed in the intake system is used to improve the intake efficiency in the respective stages of the driving range by controlling the pulsation pipe valve 200 and the resonance pipe valve 440.

In an exemplary embodiment of the present invention, two divergent resonance pipes and one pulsation pipe are used to achieve the above technique, but in another exemplary embodiment, at least two resonance pipes and one pulsation pipe can be used to achieve the above object.

For convenience in explanation and accurate definition in the appended claims, the terms “upper”, or “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable intake system, comprising:
intake runners that are respectively connected to a plurality of cylinders to supply air that flows therein to the cylinders;
a plenum, one side of which is connected to the intake runners and distributes the air to the intake runners;
a first resonance pipe, one end of which is connected to the other side of the plenum to supply the air therein;
a second resonance pipe, one end of which is connected to the other side of the plenum to supply the air therein, the length thereof being shorter than that of the first resonance pipe and the cross-section thereof being wider than that of the first resonance pipe; and
a junction pipe connected to the other ends of the first and second resonance pipes and supplying the air to the first and second resonance pipes respectively from an intake line.

2. The variable intake system of claim 1, wherein the plenum includes an upper plenum and a lower plenum that are divided in up and down directions by a plenum barrier, and
wherein the first and second resonance pipes respectively include first upper/lower pipes and second upper/lower pipes that are respectively divided by a resonance pipe barrier in up and down directions, and the plenum barrier and the resonance pipe barrier are connected to each other to be integrally formed.

3. The variable intake system of claim 1, further comprising a pulsation pipe that is diverged from the plenum and an end portion thereof is closed.

4. The variable intake system of claim 1, further comprising a pulsation pipe that is diverged from the plenum and an end portion thereof is closed, wherein
the plenum includes an upper plenum and a lower plenum that are divided in up and down directions by a plenum barrier,
the pulsation pipe includes an upper pulsation pipe and a lower pulsation pipe that are divided in up and down directions by a pulsation pipe barrier, and
the plenum barrier and the pulsation pipe barrier are connected to each other to be integrally formed.

5. The variable intake system of claim 4, further comprising:
a pulsation pipe valve that selectively open or closes a fluid communication between the upper pulsation pipe and the lower pulsation pipe;
an upper resonance pipe valve and a lower resonance pipe valve that are respectively disposed within the second upper resonance pipe and the second lower resonance pipe to selectively control the flow of the air therein;
driving portions that operate the pulsation pipe valve, the upper resonance pipe valve, and the lower resonance pipe valve respectively; and
a control portion that controls the driving portions according to a rotation speed or driving conditions of an engine.

6. The variable intake system of claim 5, wherein the control portion:
closes the pulsation pipe valve, the upper resonance pipe valve, and the lower resonance pipe valve while the rotation speed of the engine is in a low range;
opens the pulsation pipe valve and closes the upper resonance pipe valve and the lower resonance pipe valve while the rotation speed of the engine is in a medium-low range;
closes the pulsation pipe valve and opens the upper resonance pipe valve and the lower resonance pipe valve while the rotation speed of the engine is in a medium-high range; and
opens the pulsation pipe valve, the upper resonance pipe valve, and the lower resonance pipe valve while the rotation speed of the engine is in a high range.

7. The variable intake system of claim 1, further comprising a pulsation pipe that is diverged from the plenum and the end portion is closed,
wherein the plenum, the pulsation pipe, and the first and second resonance pipes are respectively divided into an upper plenum and a lower plenum, an upper pulsation pipe and a lower pulsation pipe, a first upper resonance pipe and a first lower resonance pipe, and a second upper resonance pipe and a second lower resonance pipe, by a barrier.

8. A direct injection engine system, comprising:
a variable intake system according to claim 1; and
a fuel system that directly injects fuel into a cylinder so as to generate the driving power.

9. A direct injection engine system, comprising:
a variable intake system according to claim 2; and
a fuel system that directly injects fuel into a cylinder so as to generate the driving power.

10. A direct injection engine system, comprising:
a variable intake system according to claim 3; and
a fuel system that directly injects fuel into a cylinder so as to generate the driving power.

11. A direct injection engine system, comprising:
a variable intake system according to claim 4; and
a fuel system that directly injects fuel into a cylinder so as to generate the driving power.

12. A direct injection engine system, comprising:
a variable intake system according to claim 5; and
a fuel system that directly injects fuel into a cylinder so as to generate the driving power.

13. A direct injection engine system, comprising:
a variable intake system according to claim 6; and
a fuel system that directly injects fuel into a cylinder so as to generate the driving power.

14. A direct injection engine system, comprising:
a variable intake system according to claim 7; and
a fuel system that directly injects fuel into a cylinder so as to generate the driving power.
